(19) United States
(12) Patent Application Publication
(10) Pub. No.: US 2010/0036027 A1
(43) Pub. Date: Feb. 11, 2010

(54) THERMALLY STABLE THERMOPLASTIC VULCANIZATE COMPOUNDS

(75) Inventor: David Jarus, Shaker Heights, OH (US)

Correspondence Address: POLYONE CORPORATION, 33587 WALKER ROAD, AVON LAKE, OH, 44012, US

(73) Assignee: Polyone Corporation, Avon Lake, OH (US)

(21) Appl. No.: 12/519,678

(22) PCT Filed: Dec. 28, 2007
(86) PCT No.: PCT/US2007/089015

§ 371 Date: Jun. 17, 2009

Related U.S. Application Data
(60) Provisional application No. 60/883,407, filed on Jan. 4, 2007.
(60) Provisional application No. 60/957,495, filed on Aug. 23, 2007.

(51) Int. Cl. C08K 5/00; C08L 9/00; C08L 33/20; C08L 25/06; C08K 5/13; C08K 5/52; C08K 5/17; C08K 3/34

(52) U.S. Cl. 524/140; 524/525; 524/521; 524/515; 524/323; 524/186; 524/449

(57) ABSTRACT

A high temperature thermoplastic vulcanizate is disclosed, which achieves its long term heat aging performance from a set of heat stabilizers, at least one of which stabilizes the thermoplastic phase and at least one of which stabilizes the elastomeric phase. Plastic articles made from the high temperature thermoplastic vulcanizate are also disclosed. The thermoplastic vulcanizate can be made by melt mixing or by dynamic vulcanization in an extruder.

### CLAIMS OF PRIORITY

This application claims priority from U.S. Provisional Patent Application Ser. No. 60/883,407 bearing Attorney Docket Number 12006025 and filed on Jan. 4, 2007, and from U.S. Provisional Patent Application Ser. No. 60/957,495 bearing Attorney Docket Number 12007014 and filed on Aug. 23, 2007, both of which are incorporated by reference.

### FIELD OF THE INVENTION

This invention relates to thermoplastic vulcanizate (TPV) compounds that are thermally stable, so-called “high temperature TPVs”.

### BACKGROUND OF THE INVENTION

A TPV is one type of thermoplastic elastomer (TPE). A TPE has all of the benefits of batch or continuous thermoplastic processing and elastomer performance. A TPV, as the term “vulcanizate” implies, is a crosslinked elastomer. A TPV has a rubbery discontinuous phase in a thermoplastic continuous phase.

The ability to extrude or mold thermoplastic articles that have the performance of rubber makes TPVs highly valued engineered thermoplastic materials. A wide variety of materials formerly associated with rubber, such as shoe soles, hand tool handles, weather seals, gaskets, etc. can now be made with a TPV. More importantly, a TPV retains the re-processability of a thermoplastic material as opposed to a traditional thermoset rubber which can not be re-processed. Therefore, an intermediate supplier of TPVs can sell pellets of TPV to a molder or extruder to make plastic articles of intricate form, relying on the thermoplastic properties of the TPV, in order to produce articles having vulcanized rubber properties.

TPVs previously have been limited in the nature of their performance, particularly in high heat conditions where the continuous phase of thermoplastic might begin to soften of even melt causing loss of structural integrity.

### SUMMARY OF THE INVENTION

What the art needs is a “high temperature” TPV that is tolerant of high heat conditions.

“High temperature” means a temperature approaching 150° C. and at least about 135° C.

The present invention solves that problem in the art by providing a high temperature TPV comprising a thermoplastic phase, an elastomeric phase, and a set of heat stabilizers at least one of which stabilizes the thermoplastic phase and at least one of which stabilizes the elastomeric phase.

Another aspect of the invention is an article formed from the high temperature TPV.

### EMBODIMENTS OF THE INVENTION

### TPV

Thermoplastic vulcanizates suitable for improvement by the present invention can be any TPV known to those skilled in the art, that without undue experimentation, can be combined with the set of heat stabilizers according to the present invention. Non-limiting examples of commercially available TPVs include TPVs disclosed in U.S. Pat. No. 6,774,162 (Vortkort et al.); U.S. Patent Application Publications 20050187337 (Vortkort et al.); Patent Cooperation Treaty Publications WO 2004/033551, WO 2005/012410, WO 2005/017011, WO 2005/123829, WO 2006/004698, and WO 2006/014273 (all PolyOne Corporation et al.); the disclosures of all of which are incorporated by reference as if rewritten herein.

Thermoplastic Phase of TPV

Any suitable thermoplastic material may be used as the thermoplastic phase of TPVs of the invention. Thermoplastics are generally materials that can be molded or otherwise shaped and reprocessed at temperatures at least as great as their softening or melting point.

Polyolefins are preferred thermoplastic materials. Polyolefins are a fundamental building block in polymer science and engineering because of their low cost, high volume production based on petrochemical production.

Non-limiting examples of polyolefins useful as thermoplastic olefins of the invention include homopolymers and copolymers of lower α-olefins such as 1-butene, 1-pentene, 1-hexene, 2-methyl-1-propene, 3-methyl-1-pentene, 4-methyl-1-pentene, and 5-methyl-1-hexene, as well as ethylene, butylene, and propylene, with homopolymers and copolymers of propylene being preferred. Polypropylene and olefinic copolymers of polypropylene (PP) have thermoplastic properties best explained by a recitation of the following mechanical and physical properties: a rigid semi-crystalline polymer with a modulus of about 300 MPa to about 1 GPa, a yield stress of about 5 MPa to about 35 MPa, and an elongation to ranging from about 10% to about 1,000%.

Selection of a polyolefin from commercial producers uses Melt Flow Rate (MFR) properties. The MFR can range from about 0.05 to about 1400, and preferably from about 0.5 to about 70 g/10 min at 230° C. under a 2.16 kg load. For polypropylene, that MFR should be from about 0.5 to about 70 and should be tailored to best suit the shape forming process, such as extrusion or injection molding.

Non-limiting examples of polypropylenes useful for the present invention are those commercially available from suppliers such as Dow Chemicals, Huntsman Chemicals, Formosa, Phillips, ExxonMobil Chemicals, Basell Polyolefins, and BP Amoco.

Elastomeric Phase of TPV

Any suitable elastomer can form the elastomeric phase of TPVs of the invention. It is preferred that the elastomer has a substantially saturated hydrocarbon backbone chain that causes the copolymer to be relatively inert to ozone attack and oxidative degradation, but that the elastomer may have side-chain unsaturation available for at least partial crosslinking.

Examples of suitable elastomers include natural rubber, polyisoprene rubber, styrenic copolymer elastomers (i.e., those elastomers derived from styrene and at least one other monomer, elastomers that include styrene-butadiene (SB) rubber, styrene-butadiene-styrene (SBS) rubber, styrene-ethylene-butadiene-styrene (SEBS) rubber, styrene-ethylene-ethylene-styrene (SEES) rubber, styrene-ethylene-propylene-styrene (SEPS) rubber, styrene-isoprene-styrene (SIS) rubber, styrene-isoprene-butadiene-styrene (SIBS) rubber, styrene-ethylene-propylene-styrene (SEPS) rubber, styrene-ethylene-ethylene-propylene-styrene (SEEPS) rubber, styrene propylene-styrene (SPS) rubber, and others, all of which may optionally be hydrogenated), polybutadiene rubber, nitrile rubber, butyl rubber, and olefinic elastomer such as ethylene-propylene-diene rubber (EPDM) and ethylene-octene copolymers are non-limiting examples of useful elastomers according to the invention. Especially preferred are styrenic copolymer elastomers (e.g., rubbers such as SIBS, SEBS, SBS, SEPS, and SEEPS, et cetera); nitrile rubber; and olefinic elastomers.

Particularly preferred are olefinic elastomers, especially EPDM, where the EPDM has been crosslinked partially or fully. Olefinic elastomers are especially useful in TPVs because of their reasonable cost for properties desired. Of these elastomers, EPDM is preferred because it is a fundamental building block in polymer science and engineering due to its low cost and high volume, as it is a commodity synthetic rubber since it is based on petrochemical production. EPDM encompasses copolymers of ethylene, propylene, and at least one nonconjugated diene. The benefits of using EPDM are best explained by the following mechanical and physical properties: low compression set at elevated temperatures, the ability to be oil extended to a broad range of hardness, and good thermal stability.

Selection of an olefinic elastomer from commercial producers uses Mooney Viscosity properties. The Mooney Viscosity for olefinic elastomer can range from about 1 to about 1,000, and preferably from about 20 to about 150 ML 1+4 @ 100° C. For EPDM, that Mooney Viscosity should be from about 1 to about 200, and preferably from about 20 to 70 ML 1+4 @ 100° C., when the elastomer is extended with oil. Non-limiting examples of EPDM useful for the present invention are those commercially available from multinational companies such as Bayer Polymers, Dow Chemical, Uniroyal Chemicals (now part of Lion Copolymer LLC), ExxonMobil Chemicals, DSM, Kumho, Mitsui, and others.

The elastomer itself may be provided in a variety of forms. For example, elastomers are available in liquid, powder, bale, shredded, or pelletized form. The form in which the elastomer is supplied influences the type of processing equipment and parameters needed to form the TPV. Those of ordinary skill in the art are readily familiar with processing elastomers in these various forms and will make the appropriate selections to arrive at the TPV component of the invention.

Set of Heat Stabilizers

The present invention uses a combination of heat stabilizers suitable for both the thermoplastic phase and the elastomeric phase.

Thermoplastic Phase Heat Stabilizers

Any heat stabilizer suitable for a thermoplastic polymer is a candidate for use in the present invention. Without undue experimentation, one can narrow the field of candidates to those stabilizers which assist the thermoplastic without de-stabilizing or otherwise deleteriously affecting the stability, morphology, or rheology of the elastomeric phase.

Non-limiting examples of thermoplastic phase heat stabilizers include phenolics, phosphites, phosphonites, thioesters, aliphatic amines, and epoxies, and combinations thereof.

Commercially available sources of thermoplastic phase heat stabilizers include Ciba Specialty Chemicals, Chemtura Corporation, Cytec, Dover Chemical, and others.

Elastomeric Phase Heat Stabilizers

Any heat stabilizer suitable for a thermoset polymer is a candidate for use in the present invention. Without undue experimentation, one can narrow the field of candidates to those stabilizers which assist the vulcanizate without de-stabilizing or otherwise deleteriously affecting the stability, morphology, or rheology of the thermoplastic phase.

Non-limiting examples of elastomeric phase heat stabilizers include aromatic amines, metal deactivators/chelators phenolics, phosphites, phosphonites, thioesters, and combinations thereof.

Commercially available sources of elastomeric phase heat stabilizers include Chemtura Corporation, Ciba Specialty Chemicals, Cytec, and others.

Elastomeric Phase Crosslinkers

During extrusion, the elastomers react to concurrently crosslink to form vulcanizates and become the discontinuous phase.

Any elastomeric crosslinker stabilizer suitable for a thermoset polymer is a candidate for use in the present invention. Without undue experimentation, one can narrow the field of candidates to those crosslinkers which assist to form the vulcanizate without de-stabilizing or otherwise deleteriously affecting the stability, morphology, or rheology of either the thermoplastic phase or the elastomeric phase.

Non-limiting examples of vulcanizate crosslinkers include phenolic/stannous chloride combinations (as disclosed in U.S. Pat. No. 4,311,628 (Abdou-Sabet et al.), peroxide based combinations, with and without acrylate coagents, octylphenolic resins, and combinations thereof. Phenolic crosslinkers are preferred for more stable crosslinks.

Commercially available sources of elastomeric phase crosslinkers include Schenectady International, Chemtura Corporation, Sartomer, Arkema, and others.

One can also use the catalyst-curing system of at least one phenolic resin, at least one ingredient selected from the group consisting of a non-transition metal halide and a nanoclay, optionally at least one acid and optionally at least one hydrogen halide scavenger, wherein when the ingredient is nanoclay, the phenolic resin is brominated. Preferably, when the ingredient is a non-transition metal halide, the phenolic resin is non-brominated. Preferably, the non-transition metal halide is a chloride. This system, which avoids the use of tin-containing compounds, is disclosed in Patent Cooperation Treaty Publication WO 2005/017011 (Polyone Corporation et al.), which disclosure is incorporated by reference herein as if rewritten.

Optional Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers other than those already mentioned; stearates; ultraviolet light absorbers; viscosity regulators; waxes; and combinations of them.

Another type of optional additive is a nucleating agent (also called a nucleant) to assist the morphological formation of the thermoplastic phase in the final plastic article, as disclosed in Patent Cooperation Treaty Publication WO 2005/012410 (PolyOne Corporation et al.), which is incorporated by reference herein as if rewritten.

Other optional additives are generally disclosed in Patent Cooperation Treaty Publications WO 2005/123829, WO 2006/004698, and WO 2006/014273 (all PolyOne Corporation et al.).

Table 1 shows acceptable, desirable, and preferable concentrations of each of the required and optional ingredients of TPV compounds of the present invention.

TABLE 1

| | Acceptable | Desirable | Preferred |
|---|---|---|---|
| | Range | Range | Range |
| Ingredient | (Wt. %) | (Wt. %) | (Wt. %) |
| Thermoplastic Material | 10-70 | 15-50 | 20-40 |
| Elastomeric Material* | 20-90 | 30-80 | 50-80 |
| Thermoplastic Phase | 0.05-3 | 0.1-1 | 0.2-0.8 |
| Stabilizer(s) | | | |
| Elastomeric Phase | 0.05-3 | 0.1-1 | 0.2-0.8 |
| Stabilizer(s) | | | |
| Elastomeric Phase | 0-10 | 2-9 | 4-7 |
| Crosslinker(s)** | | | |
| Other Additives*** | 0-40 | 0-40 | 0-40 |

*If vulcanizable, the elastomeric material crosslinks during reactive extrusion to form the elastomeric phase and may include extenders, such as mineral oil.
**The percent crosslinker is highly dependent upon the type of crosslinker used and need not be present if the elastomeric material is already vulcanized.
***Other additives, such as fillers, are application dependent.

Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later extrusion or molding into polymeric articles.

Reactive extrusion allows for dynamic vulcanization to occur, which is preferable when preparing TPVs. Dynamic vulcanization can advantageously reduce processing time and increase throughput. However, methods other than dynamic vulcanization can be utilized to prepare compositions of the invention when it is desired for the elastomer to be at least partially vulcanized. For example, the elastomer can be vulcanized in the absence of the thermoplastic, powdered, and mixed with the thermoplastic at a temperature above the melting or softening point of the thermoplastic to form a TPV.

A wide variety of reactive extrusion equipment can be employed for processing the mixture. Preferred is a twin screw co-rotating extruder with a length-to-diameter (L/D) ratio ranging from about 24 to about 84, and preferably from about 32 to about 64. Utilization of relatively low L/D ratio (e.g., 44 or less) extruders is possible.

To achieve vulcanization of the elastomer within the composition, the mixture is typically heated to a temperature substantially equal to or greater then the softening point of any thermoplastic employed and for a sufficient time to obtain a composition of the desired homogeneity and crosslinking of the rubber or elastomer. For example, the extrusion profile for a preferred PP/EPDM reactive extrusion can be a flat 180° C. profile and 300 rpm. The components can be fed into the reaction extruder at 27 kg/hr (60 lb/hr) using, for example, a 25-mm twin screw extruder. Lower rates may be used, for example, where the residence time needs to be higher in order to complete the degree of vulcanization desired. The actual rate and residence times needed are dependent upon the total amount of elastomer, the type of elastomer, the type and amount of curative (if used), as well as the L/D of the extruder and the precise screw design and configuration.

The components of the overall TPV composition may be added to the processing equipment in any suitable amount and in any suitable order. A suitable amount of processing oil (e.g., mineral oil and the like) can be added to the elastomer prior to addition of the thermoplastic to adjust the hardness of the TPV.

Those of skill in the art are readily able to adapt conventional TPV processing equipment and methods to incorporate minor amounts of other additives into TPV compositions according to the invention. Many variations to the preparation methods set forth above are possible and well within the knowledge of those of ordinary skill in the art of TPV compounding and preparation.

Particularly preferred as a method of making high temperature TPVs of the present invention is the use of the dynamic vulcanization processes disclosed in U.S. Pat. No. 6,774,162 (Vortkort et al.), the disclosure of which is incorporated by reference herein.

In addition to introducing the set of heat stabilizers at the time of reactive extrusion during which dynamic vulcanization of the elastomeric phase occurs, one can melt mix the set of heat stabilizers into a previously formed TPV.

Regardless of how the high temperature TPV compound is made, subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### USEFULNESS OF THE INVENTION

High temperature TPVs can be molded or extruded into a wide variety of useful plastic articles, including without limitation, gaskets, seals, grips, handles, tubing, hose, pipe, sheet, o-rings, and others.

Particularly, the high temperature TPVs can now be used in locations where previously thermoset rubbers, and other high temperature materials have been used, such as engine parts for internal combustion engines, industrial parts in manufacturing facilities, etc. Unlike thermoset rubbers, which can only be shaped once, TPVs can be molded into intricate parts or extruded in virtually unending lengths of complex cross-sections and subsequently re-processed without undue scrap. Unlike rubbers and other thermoset polymers, TPVs can be prepared and stored in inventory as pellets, particles, or powders before formation into the final shape or form. Further embodiments are found in the examples.

### EXAMPLES

### Examples 1-9 and Comparative Examples A-C

Table 2 shows the types of heat stabilizers used in the Examples and which phase they stabilize, respectively.

TABLE 2

| Stabilizer Brand | Source | Chemistry | Purpose |
|---|---|---|---|
| Irganox 1010 | Ciba | Phenolic | Thermoplastic |
| | | | Phase |
| Ethanox 330 | Ciba | Phenolic | Thermoplastic |
| | | | Phase |
| Ultranox 641 | Chemtura | Phosphite | Thermoplastic |
| | | | Phase |
| Ultranox 626 | Chemtura | Phosphite | Thermoplastic |
| | | | Phase |
| DSTDP | Chemtura | Thioester | Thermoplastic |
| | | | Phase |
| Naugard 445 | Chemtura | Aromatic | Elastomeric |
| | | amine | phase |
| XL1 | Chemtura | Chelator | Elastomeric |
| | | | phase |

Table 3 (below) shows the formulations for Comparative Examples A-C and Examples 1-9. No crosslinker was added to these formulations, but these Examples demonstrate the performance of the stabilizers for each phase of the thermoplastic elastomer (TPE) serving as a predictor for performance of the stabilizers for both phases in a high temperature TPV of the present invention.

Table 4 shows the extruder conditions, using a 16 mm Prism twin-screw extruder with all ingredients fed at the throat.

TABLE 4

| Extruder | |
|---|---|
| Conditions | Set |
| Zone 1 (° C.) | 180 |
| Zone 2 (° C.) | 190 |
| Zone 3 (° C.) | 200 |
| Zone 4 (° C.) | 200 |
| Zone 5 (° C.) | 200 |
| Zone 6 (° C.) | 200 |
| Zone 7 (° C.) | 200 |
| Zone 8 (° C.) | 200 |
| Zone 9 (° C.) | 200 |
| Die 1 (° C.) | 200 |
| RPM/Side screw | 500 |
| RPM | |

Extrudate was molded into ASTM-compliant tensile test bars.

Table 5 shows the long term heat aging test results.

TABLE 3

| Ingredient | | | | | | | | | | | | |
|---|---|---|---|---|---|---|---|---|---|---|---|---|
| (Wt. %) | A | 1 | 2 | 3 | B | 4 | 5 | 6 | 7 | C | 8 | 9 |
| Polypropylene 1- | 51.800 | 51.500 | 51.500 | 51.200 | 51.800 | 51.500 | 51.000 | 51.200 | 50.700 | 51.800 | 51.000 | 50.700 |
| 1.8 Melt Flow | | | | | | | | | | | | |
| Index | | | | | | | | | | | | |
| Nordel* 4770R | 48.000 | 48.000 | 48.000 | 48.000 | 48.000 | 48.000 | 48.000 | 48.000 | 48.000 | 48.000 | 48.000 | 48.000 |
| Ethanox 330 | 0.100 | 0.100 | 0.1000 | 0.1000 | | | | | | 0.1000 | 0.1000 | 0.1000 |
| Ultranox 626 | 0.100 | 0.100 | 0.1000 | 0.1000 | | | | | | | | |
| Irganox 1010 | | | | | 0.1000 | 0.100 | 0.1000 | 0.1000 | 0.1000 | | | |
| Ultranox 641 | | | | | 0.1000 | 0.100 | 0.1000 | 0.1000 | 0.1000 | 0.1000 | 0.1000 | 0.1000 |
| DSTDP | | | | | | | 0.5000 | | 0.5000 | | 0.5000 | 0.5000 |
| Naugard 445 | | | 0.3000 | 0.3000 | | 0.300 | 0.3000 | 0.3000 | 0.3000 | | 0.3000 | 0.3000 |
| XL1 | | 0.300 | | 0.3000 | | | | 0.3000 | 0.3000 | | | 0.3000 |
| Phase Stabilized | Therm | Both | Both | Both | Therm | Both | Both | Both | Both | Therm | Both | Both |

*EPDM commercially available from Dow Chemical.

TABLE 5

| Test | A | 1 | 2 | 3 | B | 4 | 5 | 6 | 7 | C | 8 | 9 |
|---|---|---|---|---|---|---|---|---|---|---|---|---|
| Long Term Heat | Pass | Pass | Pass | Pass | Pass | Pass | Pass | Pass | Pass | Pass | Pass | Pass |
| Aging* | | | | | | | | | | | | |
| OIT 1** | 8.1 | 14.8 | 22.7 | 34.4 | 8.3 | 26.6 | 46.7 | 26.4 | 53.1 | 6.8 | 37.1 | 46.4 |
| OIT 2** | 8.2 | 16.8 | 22.3 | 35 | 8.0 | 24.6 | 41.3 | 27.2 | 53.4 | 7.7 | 32.4 | 39.6 |
| Average OIT** | 8.15 | 15.8 | 22.5 | 34.7 | 8.15 | 25.6 | 44.0 | 26.8 | 53.25 | 6.8 | 37.1 | 46.4 |

*Suspension of ASTM tensile test bars in a 150° C. oven for 200 days under uni-axial rotation; visual determination advent of catastrophic degradation.
**Oxygen Induction Time (ASTM 3895-04), in minutes, using a Differential Scanning Calorimeter at a temperature of 220° C.

It was surprising that oven aging experiments, carried out for over 200 days, offered no differentiation among the samples, because no sign of catastrophic degradation was seen in any sample. Without being limited to a particular theory, even though no sign of catastrophic degradation was seen, the fact that even relatively un-stabilized specimens survived this test for such a long time means that PP/EPDM blends do not show traditional “mold growth” indication of catastrophic degradation. However, without the ability to differentiate samples in this standardized test, Oxygen Induction Time was seen as a viable alternative to measuring the differences in long term heat aging performance.

Three phenolic/phosphite combinations were evaluated (Comparative Examples A-C), and without any additional stabilization of the elastomeric phase, there was no discernible difference in their performance.

The addition of chelator (Examples 1 and 4) or the aromatic amine (Example 2) showed substantial improvement to any of the phenolic/phosphite combinations, with the aromatic amine being more efficient. Combinations of these two stabilizers (Examples 3 and 6) were slightly more efficient than the aromatic amine; however the results were not additive.

The addition of the thioester to the aromatic amine (Examples 5 and 8) further increased in the induction time for a given phenolic/phosphite combination.

Further addition of the chelator (Examples 7 and 9) further increased the OIT about 10 minutes for a given phenolic/phosphite combination. This complete package: phenolic/phosphite+thioester+aromatic amine+chelator achieved OITs of 40 to 50 minutes at 220° C., a very substantial OIT at this temperature.

Examples 1-9, compared with Comparative Examples A-C, demonstrated that a set of heat stabilizers for both the thermoplastic phase and the elastomeric phase provided superior long term heat aging and resulted in a high temperature TPV of the present invention. Using Examples 1-9, without undue experimentation, one skilled in the art can tailor the stabilizer set to achieve a particular OIT performance. The increase in long term heat aging should result in an increase in physical property retention at higher temperatures as well as physical properties, such as compression set and tensile properties.

### Examples 10-17 and Comparative Examples D and E

Two TPV formulations were used as controls, namely Comparative Examples D and E. Table 6 shows the formulations.

TABLE 6

| | Formulation | |
|---|---|---|
| | Examples (wt. %) | |
| | D | E |
| EPDM/PP Compound of Dutral TER 4436 Oil | 49.5 | — |
| Extended EPDM from Polimeri Europa (Italy) (140 | | |
| pbw EPDM which contains 40 pbw naphthalenic | | |
| oil) and Ineos 102-CA03 PP homopolymer from | | |
| Ineos (Cologne, Germany) (20 pbw) | | |
| Nordel IP 4770 R EPDM from Dow | — | 29.2 |
| Pionier 2097 Paraffinic Oil from Hansen and | 34.1 | 29.2 |
| Rosenthal (Hamburg) | | |
| Ineos PP 401-NA06 PP copolymer | 3.1 | — |
| Ineos PP 100-GB06 PP homopolymer | — | 29.2 |
| Polestar 200R Kaolin clay filler from Imerys of | 6.81 | 6.41 |
| Cornwall, U.K. | | |
| Zinkwiss HARZSIEGEL CF Zinc Oxide | 1.24 | 1.17 |
| vulcanization moderator from Norzinco GmbH | | |
| (Goslar, Germany) | | |
| Liga 101/6 Zinc Stearate lubricant from Peter | 1.24 | 1.17 |
| Greven Fett-Chemie (Bad Munstereifel, Germany) | | |
| Zinn(II)-Chlorid Dihydrat, krist. Ca. 97.8% | 0.31 | 0.29 |
| Stannous Chloride vulcanization activator from | | |
| Goldschmidt (Mannheim, Germany) | | |
| Tinuvin 327 Hydroxyphenylbenzotriazole from Ciba | 0.31 | 0.29 |
| Specialty Chemicals | | |
| Structol WS-280 viscosity modifier from Schill & | 1.24 | 1.17 |
| Seilacher (Hamburg) | | |
| Phenolic Resin SMD 31214 curing agent from | 1.86 | 1.75 |
| Schenactady Europe SAS (Bethune, France) | | |
| Licowax E Powder montanic acid ester mold release | 0.31 | 0.29 |
| agent from Clariant | | |

Based on the results presented for Examples 5, 6, 8, and 9 seen in Table 5 above, Comparative Examples D and E were used with those same stabilizer systems as identified in Table 3, thereby making Examples 12-19 as seen in Table 7 below.

TABLE 7

| | Stabilizer System from Table 3 | | | | | | | |
|---|---|---|---|---|---|---|---|---|
| | 6 | 9 | 5 | 8 | 6 | 9 | 5 | 8 |
| | Example (Parts by Weight) | | | | | | | |
| | 10 | 11 | 12 | 13 | 14 | 15 | 16 | 17 |
| Example D TPV Formulation | 100 | 100 | 100 | 100 | | | | |
| Example E TPV Formulation | | | | | 100 | 100 | 100 | 100 |
| Ethanox 330 (Phenolic) | | 0.1 | | 0.1 | | 0.1 | | 0.1 |
| Irganox 1010 (Phenolic) | 0.1 | | 0.1 | | 0.1 | | 0.1 | |
| Ultranox 641 (Phosphite) | 0.1 | 0.1 | 0.1 | 0.1 | 0.1 | 0.1 | 0.1 | 0.1 |
| Irganox PS 802 (Thioester) | | 0.5 | 0.5 | 0.5 | | 0.5 | 0.5 | 0.5 |
| Naugard 445 (Aromatic Amine) | 0.3 | 0.3 | 0.3 | 0.3 | 0.3 | 0.3 | 0.3 | 0.3 |
| Naugard XL-1 (Chelator) | 0.3 | 0.3 | | | 0.3 | 0.3 | | |

All Examples 10-17 and Comparative Examples D and E were processed on a Berstorff ZE40 co-rotating twin-screw extruder. This machine's L/D ratio of 57 allowed for dynamic vulcanization in one step. EPDM compound, filler and PP were added at the feed throat, oil was injected at zone 4, the phenolic resin was injected at zone 6, and the Licowax powder was dosed at zone 8. The strands produced were passed through a water bath to cool, pelletized on a strand pelletizer, and then dried for 3 hours at 80° C. before injection molding. The processing parameters in Table 8, below, were used for compounding.

TABLE 8

| Function | Set Value |
|---|---|
| Temperature - Zone 1 | — |
| Temperature - Zone 2 | 205° C. |
| Temperature - Zone 3 | 186° C. |
| Temperature - Zone 4 | 175° C. |
| Temperature - Zone 5 | 160° C. |
| Temperature - Zone 6 | 160° C. |
| Temperature - Zone 7 | 160° C. |
| Temperature - Zone 8 | 160° C. |
| Temperature - Zone 9 | 160° C. |
| Temperature - Zone 10 | 160° C. |
| Temperature - Zone 11 | 200° C. |
| Temperature - Zone 12 | 200° C. |
| Temperature - Zone 13 | 200° C. |
| Screw Speed | 450 rpm |
| Torque | 59% |
| Vacuum Degassing | 0.98 bar |
| Melt Pump | 85 rpm |
| Pressure at Melt Filter | 90 bar |
| Melt Filter | 60 μm |

Injection molded samples were tested for heat aging, by exposing plates and tensile dumbbells to 150° C. for 240 hours. Shore A durometer hardness, Tensile strength and Elongation at Break were measured according to DIN 53504 on a Zwick tensometer before and after heat aging and the difference calculated. Delta E color change was measured according to CIELAB on a color spectrophotometer, comparing heat aged plaques to un-aged plaques to measure the colour variation. Compression set values were measured according to DIN 53 517 after 22 hours at 70° C., and also after 22 hours at 100° C. to determine whether the vulcanization reaction had proceeded without problems. OIT testing was performed on each sample using a Mettler TC15 DSC calorimeter, according to test method EN-728.

Tensile tests were performed on tensile dumbbells cut from injection molded plaques, values presented are the average of values in the flow and perpendicular to flow molding directions.

Table 9 summarizes the physical, mechanical and compression set test results achieved for Comparative Examples D and E and Examples 10-17. Hardness, density and tensile values were within normal limits and would not be expected to be affected by the addition of these stabilization systems. Compression set results are a good indication of the efficiency of the vulcanization system, and identifies whether the stabilization system has affected the reaction. In Examples 10-13 and 14-17, all compression set results were close to Comparative Examples D and E, respectively, with the exception of Examples 11 and 15, which were higher than Comparative Examples D and E, respectively.

TABLE 9

| | Example | | | | | | | | | |
|---|---|---|---|---|---|---|---|---|---|---|
| | D | 10 | 11 | 12 | 13 | E | 14 | 15 | 16 | 17 |
| Density | 0.94 | 0.94 | 0.94 | 0.94 | 0.93 | 0.92 | 0.93 | 0.94 | 0.94 | 0.93 |
| (g/cm³) | | | | | | | | | | |
| Hardness | 49 | 47 | 47 | 45 | 46 | 92 | 92 | 91 | 91 | 91 |
| (Shore A) | | | | | | | | | | |
| Tensile | 2.2 | 2.2 | 3.05 | 2.15 | 2.4 | 10.3 | 10.1 | 9.7 | 10.4 | 10.2 |
| Strength | | | | | | | | | | |
| (MPa) | | | | | | | | | | |
| Elongation at | 200 | 217 | 345 | 220 | 238 | 456 | 482 | 469 | 482 | 481 |
| Break (%) | | | | | | | | | | |
| Compression | 32% | 31% | 39% | 33% | 31% | 34% | 38% | 59% | 37% | 39% |
| Set (22 h @ | | | | | | | | | | |
| 70° C.) | | | | | | | | | | |
| Compression | 30% | 32% | 41% | 33% | 29% | 48% | 39% | 71% | 50% | 46% |
| Set | | | | | | | | | | |
| (22 h @ 100° C.) | | | | | | | | | | |

Heat aging and OIT tests were performed to measure the effectiveness of the stabilization system. OIT tests performed at 180° C. all gave results in excess of 180 minutes, after which the test was stopped prematurely. OIT tests performed at 220° C. were much more useful in determining the efficiency of the stabilization system. Results are shown in Table 10, below.

TABLE 10

| Example | | | | | | | | | |
|---|---|---|---|---|---|---|---|---|---|
| D | 10 | 11 | 12 | 13 | E | 14 | 15 | 16 | 17 |

After Heat Aging (240 h @ 150° C.)

| | | | | | | | | | | |
|---|---|---|---|---|---|---|---|---|---|---|
| Change in | −39 | −34 | −30 | −30 | −44 | −50 | +0.5 | +18 | +3 | +6 |
| T.S. (%) | | | | | | | | | | |
| Change in | −23 | −20 | −8.1 | −6.4 | −28 | −85 | −16 | −12 | −16 | −13 |
| E@B (%) | | | | | | | | | | |
| Change in | 40 | 38 | 37 | 39 | 40 | 32 | 38 | 33 | 33 | 28 |
| Colour (ΔE) | | | | | | | | | | |
| OIT (220° C., | 4 | >180 | 22 | 11 | 28 | 9 | 50 | 58 | 18 | >180 |
| minutes) | | | | | | | | | | |

The heat aging results in Table 10 demonstrated a significant improvement in performance for all of Examples 10-13 over Comparative Example D but little improvement for Examples 14-17 over Comparative Example E. All Examples 10-17 and D-E showed a strong discoloration. OIT testing was very useful in determining the best performing package, with Examples 10 and 17 providing the best results, based on OIT alone.

The invention is not limited to the above embodiments. The claims follow.

What is claimed is:

1. A high temperature thermoplastic vulcanizate, comprising:
(a) a thermoplastic phase,
(b) an elastomeric phase, and
(c) a set of heat stabilizers at least one of which stabilizes the thermoplastic phase and at least one of which stabilizes the elastomeric phase.

2. The thermoplastic vulcanizate of claim 1, wherein the thermoplastic phase is continuous and the elastomeric phase is discontinuous.

3. The thermoplastic vulcanizate of claim 1, wherein the thermoplastic phase is a polymer selected from the group consisting of homopolymers and copolymers of lower α-olefins.

4. The thermoplastic vulcanizate of claim 1, wherein the elastomeric phase is a polymer selected from the group consisting of natural rubber, polyisoprene rubber, styrenic copolymer elastomers, polybutadiene rubber, nitrile rubber, butyl rubber, and olefinic elastomer, and combinations thereof.

5. The thermoplastic vulcanizate of claim 1, wherein the thermoplastic phase stabilizer is selected from the group consisting of phenolics, phosphites, thioesters, and combinations thereof.

6. The thermoplastic vulcanizate of claim 1, wherein the elastomeric phase stabilizer is selected from the group consisting of metal chelators, aromatic amines, and combinations thereof.

7. The thermoplastic vulcanizate of claim 1, further comprising a vulcanizate crosslinker and wherein the thermoplastic vulcanizate is dynamically vulcanized.

8. The thermoplastic vulcanizate of claim 1, further comprising optional additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers other than those already mentioned; stearates; ultraviolet light absorbers; viscosity regulators; waxes; and combinations of them.

9. The thermoplastic vulcanizate of claim 1,
wherein the amount of thermoplastic phase ranges from about 10 to about 70 weight percent of the thermoplastic vulcanizate;
wherein the amount of elastomeric phase ranges from about 20 to about 90 weight percent of the thermoplastic vulcanizate; and
wherein the amount of the set of stabilizers ranges from about 0.1 to about 1 weight percent of the thermoplastic vulcanizate.

10. A plastic article made from the thermoplastic vulcanizate of claim 1.

11. The plastic article of claim 10, wherein the thermoplastic phase is continuous and the elastomeric phase is discontinuous.

12. The plastic article of claim 10, wherein the thermoplastic phase is a polymer selected from the group consisting of homopolymers and copolymers of lower α-olefins.

13. The plastic article of claim 10, wherein the elastomeric phase is a polymer selected from the group consisting of natural rubber, polyisoprene rubber, styrenic copolymer elastomers, polybutadiene rubber, nitrile rubber, butyl rubber, and olefinic elastomer, and combinations thereof.

14. The plastic article of claim 10, wherein the thermoplastic phase stabilizer is selected from the group consisting of phenolics, phosphites, thioesters, and combinations thereof.

15. The plastic article of claim 10, wherein the elastomeric phase stabilizer is selected from the group consisting of metal chelators, aromatic amines, and combinations thereof.

16. The plastic article of claim 10, wherein the thermoplastic vulcanizate further comprises a vulcanizate crosslinker and wherein the thermoplastic vulcanizate is dynamically vulcanized.

17. The plastic article of claim 10, wherein the thermoplastic vulcanizate further comprises optional additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers other than those already mentioned; stearates; ultraviolet light absorbers; viscosity regulators; waxes; and combinations of them.

18. The plastic article of claim 10,
wherein the amount of thermoplastic phase ranges from about 10 to about 70 weight percent of the thermoplastic vulcanizate;
wherein the amount of elastomeric phase ranges from about 20 to about 90 weight percent of the thermoplastic vulcanizate; and
wherein the amount of the set of stabilizers ranges from about 0.1 to about 1 weight percent of the thermoplastic vulcanizate.
